(19) United States
(12) Patent Application Publication
(10) Pub. No.: US 2026/0310140 A1
(43) Pub. Date: Oct. 8, 2026

(54) ELECTRONIC TIMEPIECE, DRIVE CONTROL METHOD FOR ELECTRONIC TIMEPIECE, AND RECORDING MEDIUM

(71) Applicant: CASIO COMPUTER CO., LTD., Tokyo (JP)

(72) Inventor: Shohei SAKAMOTO, Tokyo (JP)

(21) Appl. No.: 19/636,396

(22) Filed: Apr. 1, 2026

(30) Foreign Application Priority Data
Apr. 2, 2025 (JP) 2025-061071

(51) Int. Cl. G04G 5/02; G04G 3/00; G04G 7/00

(52) U.S. Cl. CPC G04G 5/027; G04G 3/00; G04G 7/00

(57) ABSTRACT

An electronic timepiece includes: a hand; a driver; and a controller. The controller, after causing the driver to output a first drive signal, determines whether the hand has performed the rotational operation by the first drive signal, and, in response to the hand not having performed the rotational operation, executes first pulse control to cause the driver to output a second drive signal that provides an external force related to the rotational operation, the external force being greater than a force provided by the first drive signal, and the controller, for performing a predetermined functional operation at a timing of causing the hand to perform rotational operation at a time interval, performs the functional operation after executing second pulse control that is pulse control shorter than the first pulse control for outputting the second drive signal and that causes the driver to output the second drive signal.

### CROSS-REFERENCE TO RELATED APPLICATION

This application is based upon and claims the benefit of priority from the prior Japanese Patent Application No. 2025-061071, filed on April 2, 2025, the entire contents of which are incorporated herein by reference.

### BACKGROUND OF THE INVENTION

### Technical Field

The present disclosure relates to an electronic timepiece, a drive control method for an electronic timepiece, and a recording medium.

### Description of Related Art

Conventionally, there is an electronic timepiece that performs sweep hand movement that causes hand operation to appear smooth by operating a second hand at an interval shorter than 1 second. In the sweep hand movement, because a frequency of rotational operation of the hand is high, control is important such that power consumption does not become excessively large while stable operation is achieved. Japanese Unexamined Patent Application Publication No. 2013-122390 discloses technology for an electronic timepiece that can appropriately achieve both sweep hand movement and step hand movement while reducing power consumption.

### SUMMARY OF THE INVENTION

According to an aspect of the present disclosure, there is provided An electronic timepiece comprising:

a hand;

a driver configured to output a drive signal for causing the hand to perform rotational operation; and

a controller configured to control operation of the driver, wherein

the controller, for causing the hand to perform rotational operation at a time interval, after causing the driver to output a first drive signal, determines whether the hand has performed the rotational operation by the first drive signal, and, in response to the hand not having performed the rotational operation, executes first pulse control to cause the driver to output a second drive signal that provides an external force related to the rotational operation, the external force being greater than a force provided by the first drive signal, and

the controller, for performing a predetermined functional operation at a timing of causing the hand to perform rotational operation at a time interval, performs the functional operation after executing second pulse control that is pulse control shorter than the first pulse control for outputting the second drive signal and that causes the driver to output the second drive signal.

Further features of the present invention will become apparent from the following description of exemplary embodiments with reference to the attached drawings.

### BRIEF DESCRIPTION OF DRAWINGS

FIG. 1 is a block diagram illustrating a functional configuration of an electronic timepiece 1.

FIG. 2A is a diagram for explaining a drive operation of a second hand and a high-function operation interrupt.

FIG. 2B is a diagram for explaining the drive operation of the second hand and high-function operation interrupt.

FIG. 3 is a flowchart illustrating a control procedure of second-synchronous interrupt control processing.

FIG. 4A is a flowchart illustrating a control procedure of interval-timer interrupt processing.

FIG. 4B is a flowchart illustrating a control procedure of completion-timer interrupt processing.

### DETAILED DESCRIPTION

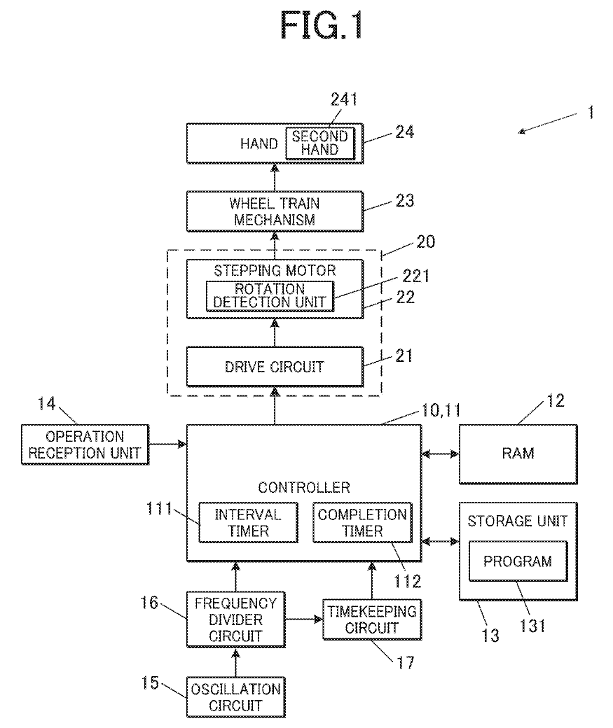

Hereinafter, embodiments will be described with reference to the drawings. As illustrated in the block diagram of FIG. 1, an electronic timepiece 1 includes a controller 11, a RAM 12 (Random Access Memory), a storage unit 13, an operation reception unit 14, an oscillation circuit 15, a frequency divider circuit 16, a timekeeping circuit 17 (timekeeping unit), a drive circuit 21, a stepping motor 22, a wheel train mechanism 23, hands 24, and the like. The electronic timepiece 1 may be a portable electronic timepiece, for example, a wristwatch.

The controller 11 includes a processor that centrally controls overall operation of the electronic timepiece 1. The processor may be a general-purpose CPU (Central Processing Unit), or may be a microcontroller for dedicated timepiece operation, an IC (Integrated Circuit), an LSI (Large-scale Integrated Circuit), or the like. The controller 11 may include a single processor, or may include a plurality of processors and may cause each of the processors to perform processing operations independently in accordance with uses and the like. Alternatively, the plurality of processors may cooperate to perform parallel processing. The controller 11 includes an interval timer 111. The interval timer 111 may not be a dedicated hardware configuration, and the processor may simply count a clock signal to calculate elapsed time. The interval timer 111 repeatedly counts a defined time from timing of a second-synchronous signal and outputs an interrupt signal each time. Hereinafter, this interrupt signal is also referred to as a timer interrupt. The controller 11 is included in a drive control apparatus 10 of the present embodiment.

The RAM 12 provides the controller 11 with a working memory space and stores temporary data. The RAM 12 stores data such as per-second hand operation count data which is data of the number of times of hand operation per second.

The storage unit 13 includes nonvolatile memory and stores a program 131, setting data, and the like. The nonvolatile memory may be, for example, flash memory. Alternatively, the type of the nonvolatile memory is not particularly limited as long as it is usable as other nonvolatile memory.

The operation reception unit 14 receives an input operation from outside and outputs an operation signal to the controller 11 in accordance with content of the received input operation. The operation reception unit 14 may include, for example, a push-button switch. In addition, the operation reception unit 14 may include a crown, a slide switch, and/or other operation mechanisms.

The oscillation circuit 15 includes, for example, a quartz crystal resonator and a resonance circuit, and generates a clock signal in the vicinity of a resonant frequency of the quartz crystal resonator. The resonant frequency may be, for example, 32.768 kHz or 16.384 kHz. The resonant frequency varies depending on environmental conditions such as temperature in addition to adjustment accuracy of the quartz crystal resonator. The quartz crystal resonator may be an AT-cut that is stable near room temperature with respect to temperature change. The frequency divider circuit 16 divides the clock signal into a signal having an appropriate frequency and outputs the divided signal. Frequencies of the divided signals may be plural, and may be defined depending on frequencies required in respective units of the electronic timepiece 1. The divided frequencies may include a 1 Hz signal for counting date and time, i.e., a signal having a period of 1 second (reference time). The frequency divider circuit 16 may include a logic pacing circuit. The logic pacing circuit can omit or add the 1 Hz signal as appropriate in accordance with a minute deviation of the 1 Hz signal.

The timekeeping circuit 17 may count the 1 Hz signal to obtain current time and date, i.e., date and time, in units of 1 second (reference time). Operation of the timekeeping circuit 17 may be included in software operation of the controller 11. That is, the electronic timepiece 1 may not include the timekeeping circuit 17 as a hardware configuration. Alternatively, separately from operation of the controller 11 as the timekeeping circuit 17, the electronic timepiece 1 may include an RTC (Real Time Clock) as a hardware configuration.

The drive circuit 21 outputs a drive signal of the stepping motor 22 based on control by the controller 11. The stepping motor 22 performs rotational operation by a defined angle in accordance with an input drive signal. The stepping motor 22 includes a rotation detection unit 221 and can detect whether rotation is present or absent by, for example, identifying, by a rotor position detection mechanism, which position a rotor is in with respect to a stator. The wheel train mechanism 23 is a gear train that converts rotation of the stepping motor 22 into rotation of the hands 24. Each hand 24 is a needle-shaped member used for displaying time and performs rotational operation, within a plane along the display surface of the electronic timepiece 1, in accordance with operation of the wheel train mechanism 23, i.e., operation of the stepping motor 22. The hands 24 may include a second hand 241, a minute hand, and an hour hand. The hands 24 may include other hands other than the second hand 241, the minute hand, and the hour hand. The other hands may have a rotation axis at a position different from those of the second hand 241, the minute hand, and the hour hand. The drive circuit 21 and the stepping motor 22 correspond to the driver 20 of the present embodiment.

Next, rotational operation of the hands 24 in the electronic timepiece 1 including the drive control method of the present embodiment will be described. In the electronic timepiece 1, time is displayed by rotation of the second hand 241, the minute hand, and the hour hand as described above. At least the second hand 241 performs rotational operation independently of other hands. The second hand 241, the minute hand, and the hour hand may each be caused to perform rotational operation independently by respective separate stepping motors 22 and wheel train mechanisms 23. Alternatively, the minute hand and the hour hand may rotate in conjunction with each other. That is, the electronic timepiece 1 may include a wheel train mechanism 23 that rotates the hour hand at a rotation angle of 1/12 of rotation of the minute hand in response to operation of a common stepping motor 22.

The second hand 241 of the electronic timepiece 1 performs rotational operation at an interval shorter than 1 second and makes one full rotation within the display surface in 1 minute. A normal second hand 241 that performs rotational operation every 1 second rotates by 6 degrees each time. In contrast, the second hand 241 of the present embodiment may rotate, as one rotational operation, by an angle obtained by dividing 6 degrees into 12, i.e., 0.5 degrees each time. That is, a unit angle by which the second hand 241 rotates in one operation is 0.5 degrees, and the second hand 241 need only perform rotational operation at an interval of about 1/12 second (a certain time interval). Such fine rotational operation at substantially equal intervals appears close to smooth rotation to a user and is also referred to as sweep hand movement. In the present disclosure, a hand that is caused to perform rotational operation at a certain time interval means the second hand 241, but the electronic timepiece 1 may include another hand that operates at an interval shorter than 1 second similarly to the second hand 241. Note that the minute hand and the hour hand may operate as in the conventional manner. For example, the minute hand may perform rotational operation by 1 degree once every 10 seconds, and the hour hand may perform rotational operation by 1 degree once every 2 minutes.

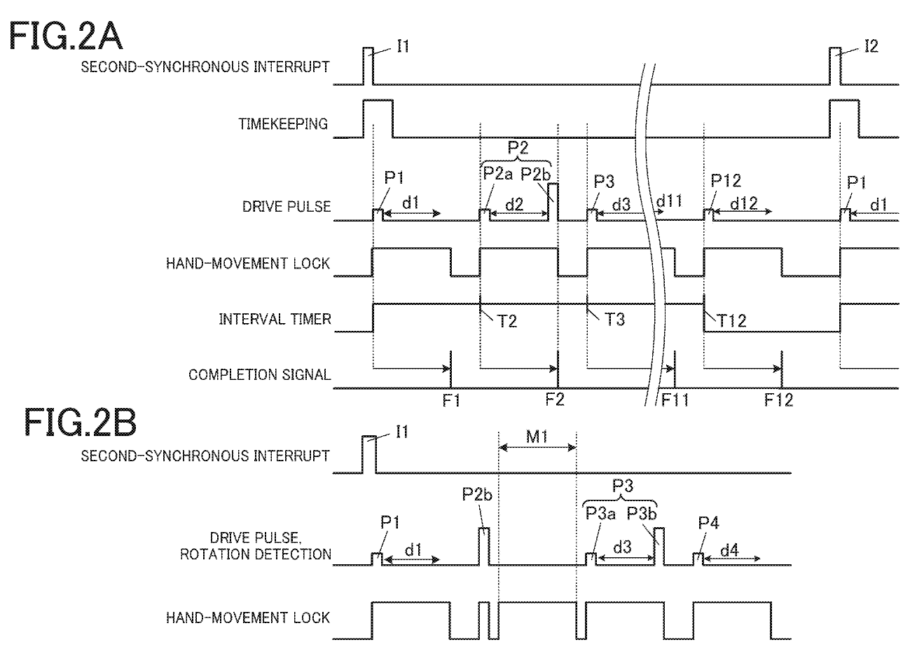

As illustrated in FIG. 2A, in the electronic timepiece 1, a second-synchronous signal synchronized with on-the-second timing at which a decimal fraction of each second becomes zero is output to the controller 11 as an interrupt. Hereinafter, this interrupt is also referred to as a second-synchronous interrupt. In response to second-synchronous interrupts I1 and I2, as timekeeping processing, counting of time and output of a drive pulse P1, which is a drive signal for operating the hands, are performed. In addition to the drive pulse P1, the electronic timepiece 1 of the present embodiment defines output timings of drive pulses P2 to P12 related to other rotational operation other than the second-synchronous timing by repeatedly measuring, by a timer, intervals of hand operation within each second. Counting of this interval is performed by the interval timer 111. That is, in the electronic timepiece 1, a frequency of output of a synchronization signal with time is not increased in accordance with the operation count (the number of times of operation) of the second hand 241. The interval timer 111 counts the interval of hand operation 11 times for each of the second-synchronous interrupts I1 and I2 and outputs interrupt signals T2 to T12, respectively. Counting operation of the interval timer 111 ends together with output of the interrupt signal T12. The drive pulses P1 to P12 are output with a duty ratio preset by pulse-width modulation (PWM).

Here, due to conditions such as reduction of power consumption, it is difficult to accurately count 1/12 second, i.e., about 83.3 milliseconds, which is an operation interval of the second hand 241. Here, “accurately” may mean, for example, accuracy or comparable accuracy such that, when an amount of deviation is accumulated for one day, an amount of time deviation falls within an upper limit value required for a timepiece, for example, within a range of ±0.5 seconds. However, in the electronic timepiece 1, as described above, counting of the interval timer 111 is reset by the second-synchronous signal every second, and thus a large error does not accumulate. In addition, a deviation of about 10 to 20 milliseconds in hand operation is hardly visually recognizable to a user and does not cause an uncomfortable feeling. Accordingly, counting of 1/12 second may be approximate. That is, a counting time of the interval timer 111 may have a deviation of, for example, up to about ±1.5 milliseconds with respect to 83.3 milliseconds. As a result, an interval between a twelfth drive pulse P12 and a first drive pulse P1 of the next second can increase or decrease somewhat compared with intervals between other drive pulses.

The drive circuit 21 outputs a drive pulse having a defined width to the stepping motor 22 in accordance with a control signal output from the controller 11 about every 1/12 second to cause the stepping motor 22 to perform rotational operation. However, the stepping motor 22 may not normally perform rotational operation due to influences such as an external magnetic field or vibration. By increasing the duty ratio, the stepping motor 22 can be rotated more reliably, but power consumption increases as the duty ratio increases. In a normal case, after the drive circuit 21 outputs a drive pulse (a first drive signal) with a low duty ratio, whether the stepping motor 22 has performed rotational operation is determined. The drive circuit 21 detects whether the stepping motor 22 has normally performed rotational operation based on a detection result of the rotation detection unit 221 of the stepping motor 22 in periods d1 to d3, etc. In a case where the stepping motor 22 has not performed rotational operation, a drive pulse (a second drive signal) that increases an external force applied to the rotor of the stepping motor 22 by increasing the duty ratio is output again. The pulse having a high duty ratio may be a continuous drive pulse in which the entire pulse is a drive voltage, i.e., the duty ratio is 100%, and the drive voltage is continuously output over the pulse width. If a ratio at which the stepping motor 22 normally performs rotational operation by the first drive signal is high, power consumption is reduced by minimizing output of the drive pulse having the high duty ratio. Here, in a drive pulse P2, in a case where it is detected that the stepping motor 22 did not normally rotate by a drive pulse P2a, a drive pulse P2b is output again. Note that rotational operation may be detected again after output of the second drive pulse.

In each driving operation, required time until output of the drive pulse ends varies depending on whether output of the second drive pulse is present or absent, but maximum hand-movement time required until end of the second output may be, for example, about 60 milliseconds. The controller 11 separately counts, by the completion timer 112, the maximum hand-movement time from start of output of the first drive pulse. The maximum hand-movement period defines a hand-movement lock period during which output of a control signal for a next drive pulse is prohibited. The completion timer 112 outputs interrupt signals F1 to F12 each time the maximum hand-movement period is counted, and the hand-movement lock is released at this timing. That is, the interrupt signals F1 to F12 are signals for releasing the hand-movement lock. In a case where, for some reason, the interrupt signals F1 to F12 do not occur by a timer interrupt by the next interval timer 111, the next drive pulse is also brought into a standby state.

On the other hand, in the electronic timepiece 1, other high-load functional operations with large power consumption occur intermittently. Examples of such operations include generation of a buzzer sound and light emission of an LED for detecting a hand position. To obtain battery power supply capability necessary to stably perform these operations and the operation of the stepping motor 22 at the same time, it is necessary to increase battery size and cost. To avoid this, in the electronic timepiece 1, timings of respective operations are controlled so that rotational operation of the hands 24 and the high-load functional operation are not performed simultaneously, in a mutually exclusive manner.

However, in the sweep hand movement, as described above, a hand-movement lock period corresponding to the maximum hand-movement period of about 60 milliseconds occurs every 83.3 milliseconds. As a result, a sum of the maximum hand-movement period and a shortest time required for the high-load functional operation can become longer than a counting time of the interval timer 111, i.e., the operation interval of the second hand 241. In a case where such a high-load functional operation is executed, it is necessary to extend a release period of the hand-movement lock while maintaining reliability of hand movement.

As illustrated in FIG. 2B, in a case where a high-load functional operation is executed, the electronic timepiece 1 outputs, from the beginning of the hand movement, a drive pulse P2b (a second drive signal) having a high duty ratio to release the hand-movement lock early. Accordingly, a period during which the hand-movement lock is released is extended to, for example, about 50 to 75 milliseconds. After output of the drive pulse P2b, a high-load functional operation M1 is performed during the extended release period. By completion of the high-load functional operation M1 before an interrupt signal T3 by a next interval timer, hand movement of the hands 24 and the high-load functional operation M1 are executed mutually exclusively without having an overlap period.

Output of a buzzer sound may be performed consecutively in release periods of outputs two times or more of about 50 to 75 milliseconds as described above. In addition, depending on a pattern of an output sound, the buzzer sound may be output with an appropriate number of release periods in which the buzzer sound is not output interposed therebetween.

Inspection of a hand position may be performed, for example, by identifying a position of a through hole included in a gear of the wheel train mechanism 23. At a position at which a plurality of gears overlap in plan view, through holes of the plurality of gears overlap when the plurality of gears are in a specific positional relationship. Whether the hand position is accurate can be determined based on whether the timing of overlapping is correct. At a position at which the through holes overlap, light is projected from outside of one gear by a light emitting unit, and light that has passed through the through holes is detected by a light receiving unit on a side of the other gear, thereby identifying timing at which the through holes overlap. The light emitting unit may be, for example, an LED, and the light receiving unit may be, for example, a photodiode. Light emission operation of the light emitting unit and received-light amount measurement by the light receiving unit may be continuously performed not only at correct timing at which the through holes overlap but also in accordance with respective one or more hand-movement timings before and after the correct timing. In addition, depending on a rotation angle of the gear and a size of the through hole, there is a case where the through holes partially or entirely overlap over a plurality of hand movements. Therefore, whether the hand is in a correct position may be detected by specifying a period, rather than one timing, during which a received-light amount by the light receiving unit increases.

In addition, the high-load functional operation may include measurement of an output voltage of the battery. The voltage measurement itself is not necessarily high-load processing, but, during processing having a large load such as rotational operation of the hands 24, the voltage decreases and varies, and thus accurate voltage measurement can be difficult in some cases. Accordingly, as described above, the output voltage may be measured in a period exclusive of the hand-movement lock period related to rotational operation of the hands 24. The inspection of the output voltage may be scheduled to be performed periodically at a defined interval, for example, at an appropriate time once every several hours to once a day.

Among the examples described above, inspection of the hand position and measurement of the output voltage of the battery have execution timing determined in advance based on time information. Also in buzzer output, notification operation of an alarm time, etc. has execution time determined. Therefore, in the electronic timepiece 1, based on current date and time updated in timekeeping processing related to the second-synchronous interrupt, it is judged whether current time includes timing for executing the high-load functional operation. In a case where timing for executing the high-load functional operation is included, the electronic timepiece 1 further specifies at which timing among the drive pulses P1 to P12 the high-load functional operation is executed. By setting in advance a range in which the high-load functional operation is executed, within the range, a pattern of drive pulses to be output is changed. Note that, in the schedule of each high-load functional operation described above, only a start timing, or a start timing and a duration or an end timing, may be defined. In this case, whether the specific high-load functional operation is executed at each hand-movement timing within an execution period may be sequentially determined based on an elapsed time from the time of the start timing.

In buzzer output, etc. based on a user input operation, because acceptance of an input operation is acquired in real time, the schedule is not set in advance. In this case, not limited to the second-synchronous interrupt, presence or absence of the high-load functional operation may be determined for each interrupt by the interval timer 111.

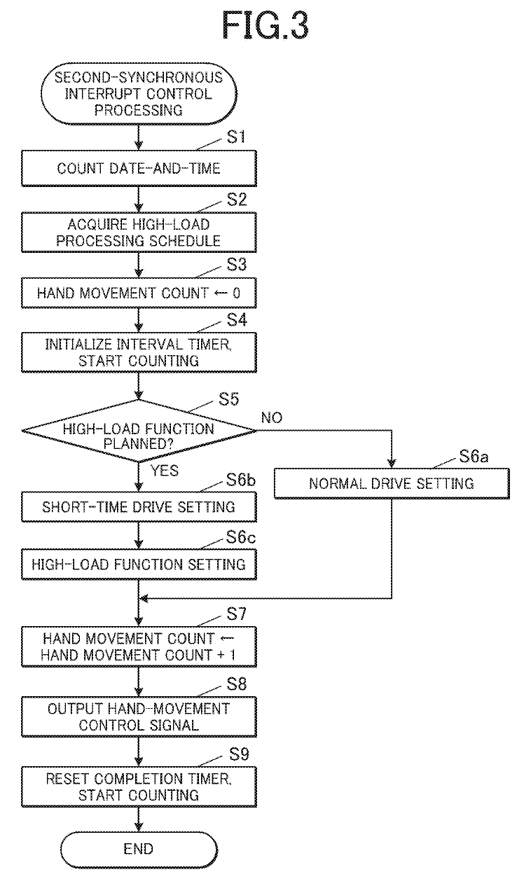

The second-synchronous interrupt control processing illustrated in FIG. 3 is executed with a second-synchronous interrupt as a trigger. The controller 11 performs date-and-time counting processing (S1). The controller 11 updates the current date and time held by adding 1 second thereto. The controller 11 acquires a schedule of high-load processing for the updated date and time (S2).

The controller 11 initializes the hand movement count (the number of times of hand movement) to zero (S3). The controller 11 initializes the interval timer 111 and starts counting (S4). The controller 11 determines whether an execution plan of a high-load functional operation is present at a current hand-movement timing, i.e., at a first hand movement at the current date and time in units of seconds (S5). In a case where it is determined that an execution plan of a high-load functional operation is not present (S5; NO), the controller 11 performs a normal drive setting as first pulse control to output a normal drive pulse in 60 milliseconds (S6a). Thereafter, processing of the controller 11 proceeds to step S7. In a case where it is determined that an execution plan of a high-load functional operation is present (S5; YES), the controller 11 performs a short-time drive setting as second pulse control to output a drive pulse having a high duty ratio (S6b). The controller 11 may perform, at this timing, an execution setting of a high-load function after the hand-movement operation (S6c). Thereafter, processing of the controller 11 proceeds to step S7.

When proceeding to step S7, the controller 11 increments the hand movement count by 1 (S7). The controller 11 outputs a hand-movement control signal in accordance with the setting to the drive circuit 21 (S8). The controller 11 resets the completion timer 112 and starts counting (S9). Then, the controller 11 ends the second-synchronous interrupt control processing.

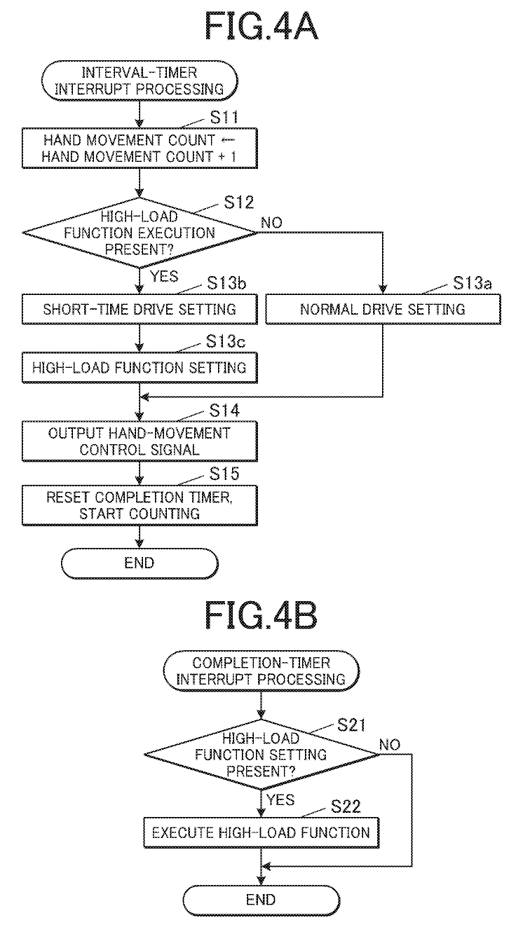

The interval-timer interrupt processing illustrated in FIG. 4A is executed with occurrence of an interrupt by the interval timer 111 as a trigger. The controller 11 increments the hand movement count by 1 (S11). The controller 11 determines whether execution of high-load functional processing is present at timing of a current hand movement count of the current date and time (S12). In a case where it is determined that execution of high-load functional processing is present (S12; YES), the controller 11 performs, as second pulse control, a setting of short-time driving (S13b). The controller 11 may perform, at this timing, an execution setting of a high-load function after the hand-movement operation. Thereafter, processing of the controller 11 proceeds to step S14. In a case where it is determined that execution of high-load functional processing is not present (S12; NO), the controller 11 performs, as first pulse control, a setting of normal driving (S13a). Thereafter, processing of the controller 11 proceeds to step S14.

When proceeding to step S14, the controller 11 outputs a hand-movement control signal to the drive circuit 21 in accordance with the setting (S14). The controller 11 resets the completion timer 112 and starts counting (S15). Then, the controller 11 ends the interval-timer interrupt processing.

The completion-timer interrupt processing illustrated in FIG. 4B is executed with an interrupt by the completion timer 112 as a trigger. The controller 11 determines whether execution of high-load functional processing is present (S21). In a case where execution of high-load functional processing is present (S21; YES), the controller 11 executes the high-load functional processing (S22). Then, the controller 11 ends the completion-timer interrupt processing. In a case where execution of high-load functional processing is not present (S21; NO), the controller 11 ends the completion-timer interrupt processing.

As described above, a drive control apparatus 10 of the electronic timepiece 1 of the present embodiment includes the controller 11 that controls operation of the driver 20 configured to output a drive signal for causing the second hand 241 to perform rotational operation. When causing the second hand 241 to perform rotational operation at a certain time interval, here, at an interval of about 1/12 second, the controller 11, after causing the driver 20 to output a first drive signal, determines whether the second hand 241 has performed rotational operation by the first drive signal, and, in a case where the second hand 241 has not performed rotational operation, performs first pulse control to cause the driver 20 to output a second drive signal that applies to the rotor of the stepping motor 22 an external force related to rotational operation that is greater than that of the first drive signal. In a case where a predetermined functional operation is to be performed at timing of causing the second hand 241 to perform rotational operation at the certain time interval, the controller 11 performs the functional operation after executing second pulse control that is pulse control shorter than the first pulse control in a case of causing output of the second drive signal and that causes the driver 20 to output the second drive signal. In this manner, the drive control apparatus 10 stably causes the second hand 241 to perform rotational operation while reducing power consumption in normal hand movement, particularly in a case where a hand-movement interval is short such as in sweep hand movement. On the other hand, in a case where a functional operation, particularly a high-function operation having a large load, is executed, the drive control apparatus 10 outputs a drive signal capable of reliably causing the second hand 241 to perform rotational operation in one time. Accordingly, the drive control apparatus 10 can shorten time required for output of the drive signal and secure time for executing the high-function operation thereafter. According to the disclosure of Japanese Unexamined Patent Application Publication No. 2013-122390 described above, in a case where an electronic timepiece performs some functional operation separately from normal hand-movement control, there is a possibility that influence propagates between processing related to the functional operation and the hand-movement operation. In contrast, according to the present disclosure, because the functional operation and the hand-movement operation are not performed simultaneously, it is possible to avoid a situation in which load becomes a problem and malfunction of respective units occurs. In addition, it is possible to avoid a situation in which electromagnetic waves, etc. generated in accordance with rotational operation of the stepping motor 22 in the hand-movement operation affect the functional operation, for example, magnetic field measurement, current measurement, voltage measurement, and transmission and reception of radio waves. Therefore, the drive control apparatus 10 and the electronic timepiece 1 including the drive control apparatus 10 can reduce propagation of influence between the functional operation and the hand-movement operation.

In addition, in the second pulse control, the controller 11 may not cause the driver 20 to output the first drive signal and may not determine whether the second hand 241 has performed rotational operation by the first drive signal. In this manner, by causing output of a drive pulse capable of causing the second hand 241 to perform rotational operation almost certainly, a need to output a second drive pulse is reduced. Accordingly, the drive control apparatus 10 can end the hand-movement operation in a shorter time than usual. Further, because a need to detect whether rotational operation has actually been performed is also reduced, by omitting this, time required for hand-movement control can be further shortened. Accordingly, the drive control apparatus 10 can execute the functional operation without overlapping the hand-movement operation and can reduce a possibility that the functional operation and the hand-movement control influence each other.

In addition, a time interval for causing the second hand 241 to perform rotational operation may be shorter than 1 second and may be synchronized with passage of time. In a case where it is difficult to shift operation timing, such as hand operation synchronized with time, other functional operations must be performed in gaps between operations that are difficult to shift. Therefore, particularly in a case where such a gap is narrow, by efficiently shortening time required for the hand-movement operation, it is possible to enable execution of the functional operation.

In addition, a sum of a time from a start of output of the first drive signal to an end of output of the second drive signal and a time required for another functional operation may be longer than a time interval for causing the second hand 241 to perform rotational operation. In this case, the functional operation cannot be executed unless time required for driving of the second hand 241 is shortened. On the other hand, as described above, if it is attempted to reliably cause the second hand 241 to perform rotational operation by one drive signal at all times, power consumption increases. Therefore, by appropriately switching output of the drive signal depending on whether the functional operation is executed, the drive control apparatus 10 and the electronic timepiece 1 can achieve both efficient hand movement and execution of the functional operation.

In addition, the drive signal may be a pulse-width-modulated signal, and a magnitude of the external force may be defined by a duty ratio of the pulse-width modulation. In PWM control, the duty ratio can be finely changed and the pulse width is not changed, and thus PWM control is suitable for time-division processing by which the drive control apparatus 10 and the electronic timepiece 1 perform the hand-movement operation and the functional operation.

In addition, the electronic timepiece 1 of the present embodiment includes the second hand 241 and the driver 20 configured to output a drive signal for causing the second hand 241 to perform rotational operation. According to the electronic timepiece 1, even in a case where the second hand 241 is caused to perform sweep operation, it is possible to execute the functional operation in between, and sweep hand movement and the functional operation can be achieved together with efficient power consumption.

In addition, the drive control method of the present embodiment includes the following steps. When causing the second hand 241 to perform rotational operation at a certain time interval, in a normal case, as first pulse control, (1A) after causing the driver 20 to output the first drive signal, it is determined whether the second hand 241 has performed rotational operation by the first drive signal. (2A) In a case where the second hand 241 has not performed rotational operation, the driver 20 is caused to output a second drive signal that provides an external force related to the rotational operation that is greater than the first drive signal. On the other hand, in a case where a predetermined functional operation is to be performed at timing of causing the second hand 241 to perform rotational operation at the certain time interval, the following control steps are included. (1B) As second pulse control shorter than the first pulse control in a case including (2A) described above, the driver 20 is caused to output the second drive signal. (2B) Thereafter, the functional operation is performed. With this drive control method, sweep hand movement is possible while suppressing power consumption, and the functional operation can be appropriately interposed and executed between hand movements. Therefore, according to the present drive control method, it is possible to reduce a possibility that influence extends between the functional operation and the hand-movement operation.

Note that the above embodiment is an example, and various modifications are possible. For example, in the above description, sweep hand movement of the second hand 241 in time display has been described as an example, but the present disclosure is not limited thereto. The present disclosure can also be applied to a functional operation during sweep hand movement related to display of an elapsed time linked with passage of time. In addition, even in a case where a display shorter than 1 second, for example, 1/10 second, is performed by a function hand other than the second hand 241, it is possible to achieve both hand movement and the functional operation.

In addition, as long as display contents require the hand to perform rotational operation step by step linked with passage of time, contents other than seconds may be indicated, respectively. An electronic device that displays such display contents by the drive control apparatus 10 may not be an electronic timepiece.

In addition, in a case where processing time required for the functional operation is long, the processing content of the present embodiment can be applied even in a case where an interval of hand operation such as the second hand 241 is wider than that of the above embodiment. On the other hand, although the term “high-load functional operation” is used above, a magnitude of load related to the functional operation is not necessarily limited. Even load processing executable in parallel with rotation of the stepping motor 22 can be executed, as described above, in a time-divided manner, mutually exclusively with the hand-movement operation. In addition, regardless of whether the time required for the functional operation is longer or shorter, a unit time related to operation of the hand such as the second hand 241 may be appropriately set.

In addition, although rotation detection of the stepping motor 22 is not performed after the second drive signal in the above description, rotation detection may be performed depending on a balance between the unit time and the time required for the functional operation, and the like. In addition, since it is sufficient as long as rotation of the second hand 241 is specified, instead of rotation detection of the stepping motor 22, rotation detection of the wheel train mechanism 23 or the second hand 241 may be performed.

In addition, although the above description has described that the drive signal is PWM-controlled and the duty ratio is adjusted, the present disclosure is not limited thereto. A pulse width, etc. of the drive signal may be changed and adjusted.

In addition, in the above description, the storage unit 13 including nonvolatile memory such as flash memory has been described as an example of a computer-readable medium storing the program 131 related to hand-movement control of the present disclosure, but the present disclosure is not limited thereto. As other computer-readable media, it is possible to apply other nonvolatile memory such as MRAM, or portable recording media such as a CD-ROM and a DVD disk. In addition, a carrier wave is also applicable as a medium for providing data of the program related to the present disclosure via a communication line. In addition, specific configurations, contents and procedures of processing operations, and the like shown in the above embodiment can be appropriately changed without departing from the spirit of the present disclosure. The scope of the present invention includes the scope of the invention described in the claims and equivalents thereof.

What is claimed is:

1. An electronic timepiece comprising:
a hand;
a driver configured to output a drive signal for causing the hand to perform rotational operation; and
a controller configured to control operation of the driver, wherein
the controller, for causing the hand to perform rotational operation at a time interval, after causing the driver to output a first drive signal, determines whether the hand has performed the rotational operation by the first drive signal, and, in response to the hand not having performed the rotational operation, executes first pulse control to cause the driver to output a second drive signal that provides an external force related to the rotational operation, the external force being greater than a force provided by the first drive signal, and
the controller, for performing a predetermined functional operation at a timing of causing the hand to perform rotational operation at a time interval, performs the functional operation after executing second pulse control that is pulse control shorter than the first pulse control for outputting the second drive signal and that causes the driver to output the second drive signal.

2. The electronic timepiece according to claim 1, wherein, in the second pulse control, the controller does not cause the driver to output the first drive signal and does not determine whether the hand has performed the rotational operation by the first drive signal.

3. The electronic timepiece according to claim 1, wherein the time interval is shorter than 1 second and is synchronized with passage of time.

4. The electronic timepiece according to claim 1, wherein a sum of a time from a start of output of the first drive signal to an end of output of the second drive signal and a time required for the functional operation is longer than the time interval.

5. The electronic timepiece according to claim 1, wherein the drive signal is a pulse-width-modulated signal, and a magnitude of the external force is defined by a duty ratio of pulse-width modulation.

6. A drive control method for an electronic timepiece that includes a hand and a driver configured to output a drive signal for causing the hand to perform rotational operation, the drive control method comprising:
for causing the hand to perform rotational operation at a time interval, after causing the driver to output a first drive signal, determining whether the hand has performed the rotational operation by the first drive signal, and, in response to the hand not having performed the rotational operation, executing first pulse control to cause the driver to output a second drive signal that provides an external force related to the rotational operation, the external force being greater than a force provided by the first drive signal; and
for performing a predetermined functional operation at a timing of causing the hand to perform rotational operation at a time interval, performing the functional operation after executing second pulse control that is pulse control shorter than the first pulse control for outputting the second drive signal and that causes the driver to output the second drive signal.

7. The drive control method for the electronic timepiece according to claim 6, wherein, in the second pulse control, the controller does not cause the driver to output the first drive signal and does not determine whether the hand has performed the rotational operation by the first drive signal.

8. The drive control method for the electronic timepiece according to claim 6, wherein the time interval is shorter than 1 second and is synchronized with passage of time.

9. The drive control method for the electronic timepiece according to claim 6, wherein a sum of a time from a start of output of the first drive signal to an end of output of the second drive signal and a time required for the functional operation is longer than the time interval.

10. The drive control method for the electronic timepiece according to claim 6, wherein the drive signal is a pulse-width-modulated signal, and a magnitude of the external force is defined by a duty ratio of pulse-width modulation.

11. A non-transitory computer-readable recording medium storing a program for a computer included in an electronic timepiece that includes a hand and a driver configured to output a drive signal for causing the hand to perform rotational operation, the program causing the computer to perform:
for causing the hand to perform rotational operation at a time interval, after causing the driver to output a first drive signal, determining whether the hand has performed the rotational operation by the first drive signal, and, in response to the hand not having performed the rotational operation, executing first pulse control to cause the driver to output a second drive signal that provides an external force related to the rotational operation, the external force being greater than a force provided by the first drive signal; and
for performing a predetermined functional operation at a timing of causing the hand to perform rotational operation at a time interval, performing the functional operation after executing second pulse control that is pulse control shorter than the first pulse control for outputting the second drive signal and that causes the driver to output the second drive signal.

12. The recording medium according to claim 11, wherein, in the second pulse control, the controller does not cause the driver to output the first drive signal and does not determine whether the hand has performed the rotational operation by the first drive signal.

13. The recording medium according to claim 11, wherein the time interval is shorter than 1 second and is synchronized with passage of time.

14. The recording medium according to claim 11, wherein a sum of a time from a start of output of the first drive signal to an end of output of the second drive signal and a time required for the functional operation is longer than the time interval.

15. The recording medium according to claim 11, wherein the drive signal is a pulse-width-modulated signal, and a magnitude
of the external force is defined by a duty ratio of pulse-width modulation.
